(19) United States
(12) Patent Application Publication
(10) Pub. No.: US 2015/0285452 A1
(43) Pub. Date: Oct. 8, 2015

(54) Light bulb emitting two different colors

(71) Applicant: JOHN H.J. LIN, Taichung City (TW)

(72) Inventor: JOHN H.J. LIN, Taichung City (TW)

(21) Appl. No.: 14/668,993

(22) Filed: Mar. 26, 2015

(30) Foreign Application Priority Data
Apr. 2, 2014 (TW) 103205680

(51) Int. Cl. F21S 10/02; F21V 3/02; F21V 23/00

(52) U.S. Cl. CPC F21S 10/023; F21V 23/005; F21V 3/02; F21Y 2113/005

(57) ABSTRACT

A light bulb includes a base and a top portion is connected to the base. A control circuit is installed within the top portion and is connected with the base. A board is connected to the top portion and a first LED is connected to the center thereof. Multiple second LEDs are connected to the board and located around the first LED. The first LED and the second LEDs generate different colors. The control circuit controls the first LED and the second LEDs to be activated separately or simultaneously. A globe is connected to the top portion and accommodates the first LED and the second LEDs. The light bulb emits a single color or different colors simultaneously.

### BACKGROUND OF THE INVENTION

1. Fields of the Invention

The present invention relates to a light bulb, and more particularly, to a light bulb that has multiple Light Emitting Diodes to emit at least two different colors.

2. Descriptions of Related Art

The conventional light bulbs use filaments to generate light and the filaments consume too much energy and generate heat. There are energy-saving light bulbs developed and use Light Emitting Diodes (LEDs) to generate light while the consumption of the energy and the heat is greatly reduced. Nevertheless, the conventional light bulbs using LEDs can only emit a single color. In order to improve the shortcoming, a color changeable light bulb is developed, and which comprises a copper base in which multiple Second LEDs are installed. An inner cover is connected to the base and an outer cover is mounted to the inner cover. The top surface of the inner cover and the bottom of the outer cover are coated with refraction metallic layer to increase the illumination and the range of the light bulb. The Second LEDs are controlled by an automatic switch system to generate different colors.

Another color changeable light bulb uses a rotatable globe which is mechanically rotated to generate the cool light and warm light. The two different color changeable light bulbs each actually are operated to active only the first color in one time, and when the light bulb is switched to the second color, the first color is turned off. In other words, the two colors cannot be operated simultaneously.

The present invention intends to provide a light bulb which can be operated to generate either one of the two different colors, or to generate the two different colors simultaneously.

### SUMMARY OF THE INVENTION

The present invention relates to a light bulb and comprises a base and a top portion is connected to the base. A control circuit is installed within the top portion and connected with the base. A board is connected to the top portion and has a first Light Emitting Diode (LED) connected to the center thereof. At least one LED unit is located on the board and around the first LED. The at least one LED unit comprises multiple second LEDs which are located around the first LED. The first LED and the second LEDs generate different colors. The first LED and the at least one LED unit are electrically connected to the control circuit which controls the first LED and the at least one LED unit to be activated separately or simultaneously. A globe is connected to the top portion and accommodates the first LED and the at least one LED unit.

The primary object of the present invention is to provide a light bulb that comprises a first LED at the center of the top portion and multiple second LEDs are located around the first LED. A control circuit controls the first LED and second LEDs of the at least one LED unit to be activated separately or simultaneously.

Another object of the present invention is to provide a light bulb which can be used as a table lamp by activating the second LEDs. The light bulb can also be used as a night light by activating the first LED.

Yet another object of the present invention is to provide a light bulb wherein second LEDs are arranged to form multiple loops around the first LED. The second LEDs can be designed to generate more than two different colors.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the light bulb of the present invention;

FIG. 2 is an exploded view of the light bulb of the present invention;

FIG. 3 shows that the globe is to be connected to the top portion of the light bulb of the present invention;

FIG. 4 shows that the second LEDs of the light bulb of the present invention are activated;

FIG. 5 shows that the first LED of the light bulb of the present invention is activated;

FIG. 6 shows that the first LED and the second LEDs of the light bulb of the present invention are activated, and

FIG. 7 is a perspective view to show that the light bulb of the present invention is used as a table lamp.

### DETAILED DESCRIPTION OF THE PREFERRED EMBODIMENT

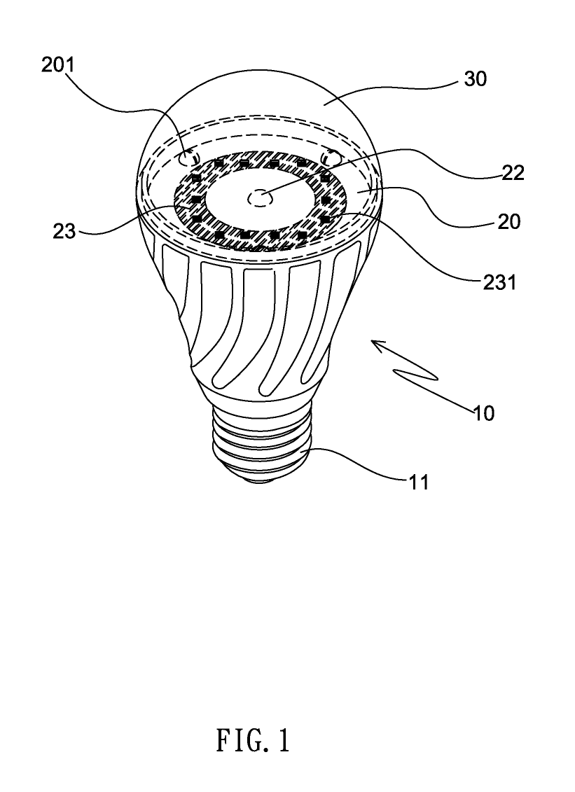

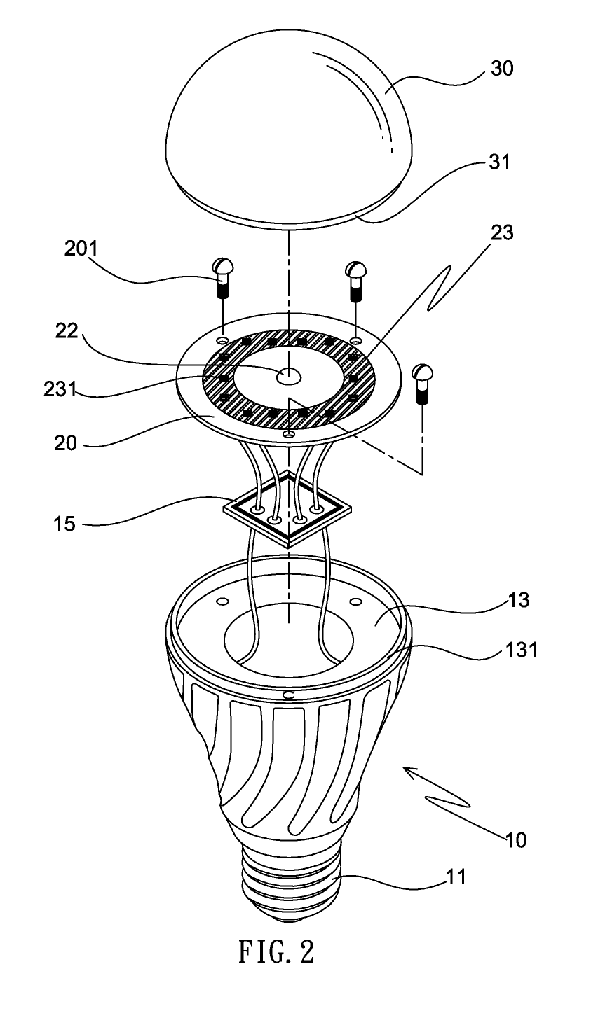

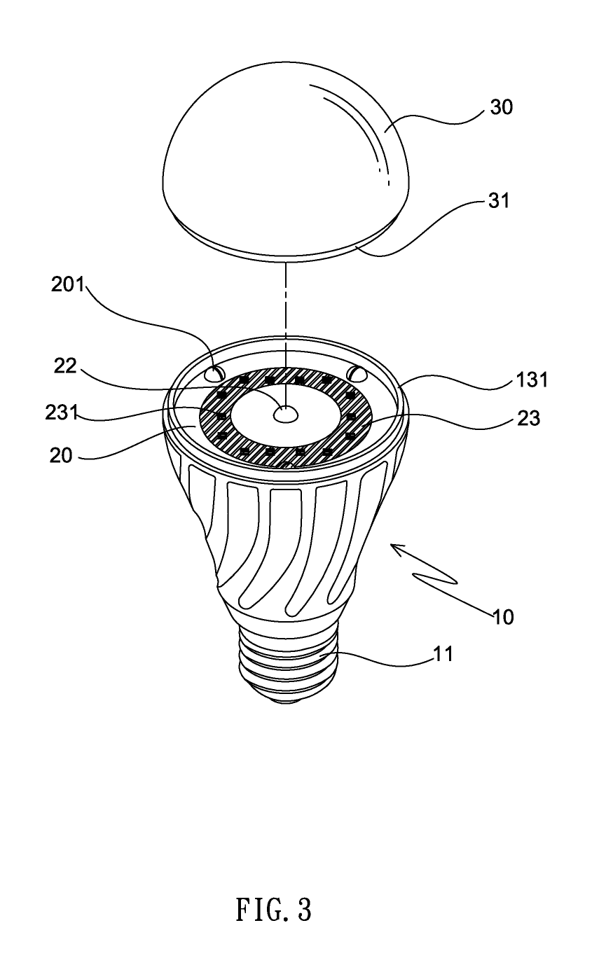

Referring to FIGS. 1 to 3, the light bulb 10 of the present invention comprises a base 11 and a top portion 13 is connected to the base 11. The base 11 has outer threads so as to be connected with an electric power unit which is not shown. The top portion 13 has a loop-like plate on the open top thereof. A first flange 131 extends from a periphery of the open top of the top portion 13. A control circuit 15 is installed within the top portion 13 and connected with the base 11.

A board 20 is connected to the loop-like portion of the top portion 13 by bolts 201 and has a first Light Emitting Diode (LED) 22 connected to the center thereof. At least one LED unit 23 is located on the board 20 and around the first LED 22. The at least one LED unit 23 has multiple second LEDs 231 connected thereto which are located around the first LED 22. The first LED 22 and the second LEDs 231 generate different colors. For example, the first LED 22 generates yellow light and the second LEDs 231 generate while light. The first LED 22 and the second LEDs 231 are exposed from the top portion 13. The first LED 22 and the at least one LED unit 23 are electrically connected to the control circuit 15 which controls the first LED 22 and the second LEDs 231 of the at least one LED unit 23 to be activated separately or simultaneously.

The light bulb 10 can be equipped with multiple LED units 23 of different diameters and each LED unit 23 comprises multiple second LEDs 231. The second LEDs 231 of the different LED units 23 generate different colors of light. The arrangement and density of the second LEDs 231 can be varied according to practical needs.

A transparent glass globe 30 has a second flange 31 which is connected to the first flange 131 so as to connect the globe 30 to the base 11 as shown in FIG. 1.

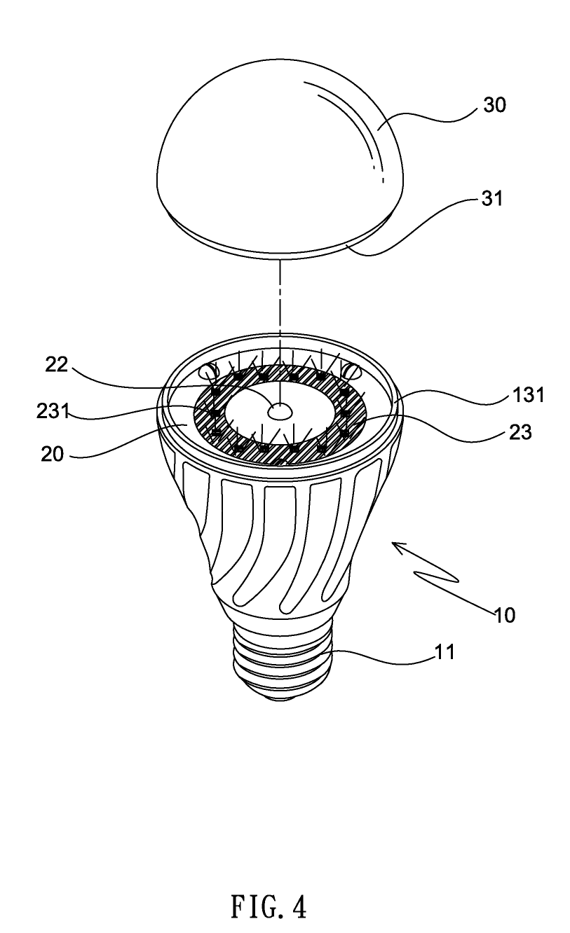

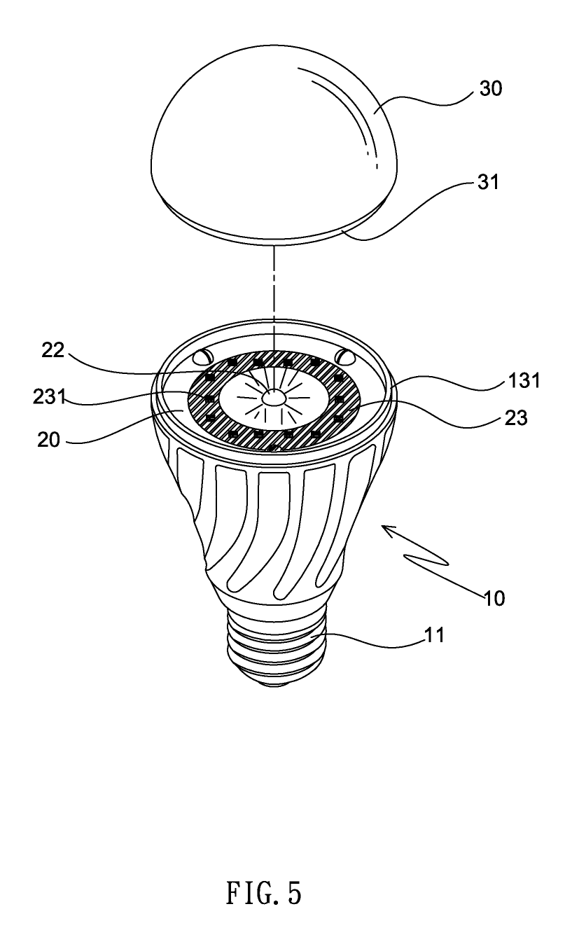

As shown in FIG. 4, by operation of the control circuit 15 to the first position, the second LEDs 231 of the light bulb 10 are activated while the first LED is not activated. When the control circuit 15 is switched to the second position, only the first LED 22 of the light bulb is activated while the second LEDs 231 are not activated as shown in FIG. 5.

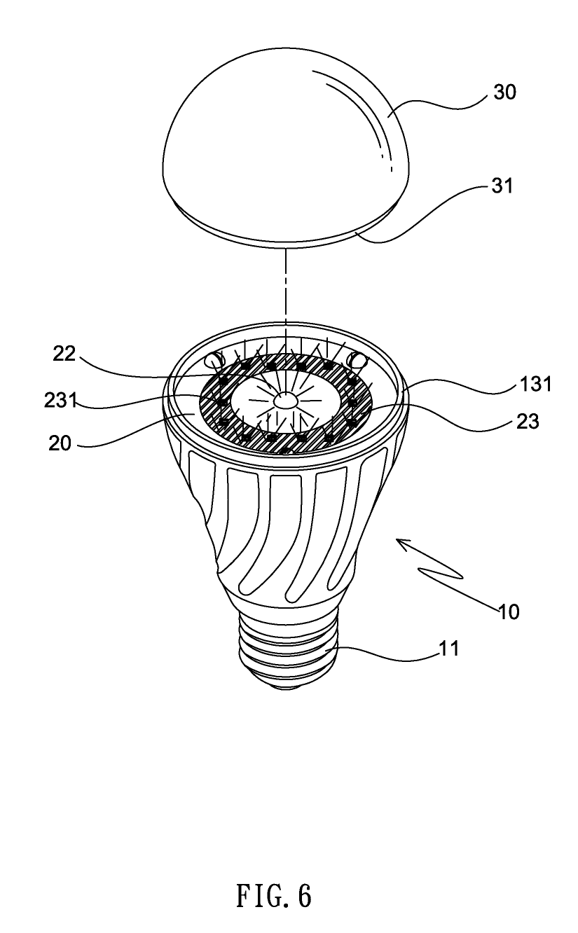

As shown in FIG. 6, when the control circuit 15 is switched to the third position, the first LED 22 and the second LEDs 231 of the light bulb are all activated. The second LEDs 231 are arranged as a loop and generate while light, and the first LED 22 generates yellow light.

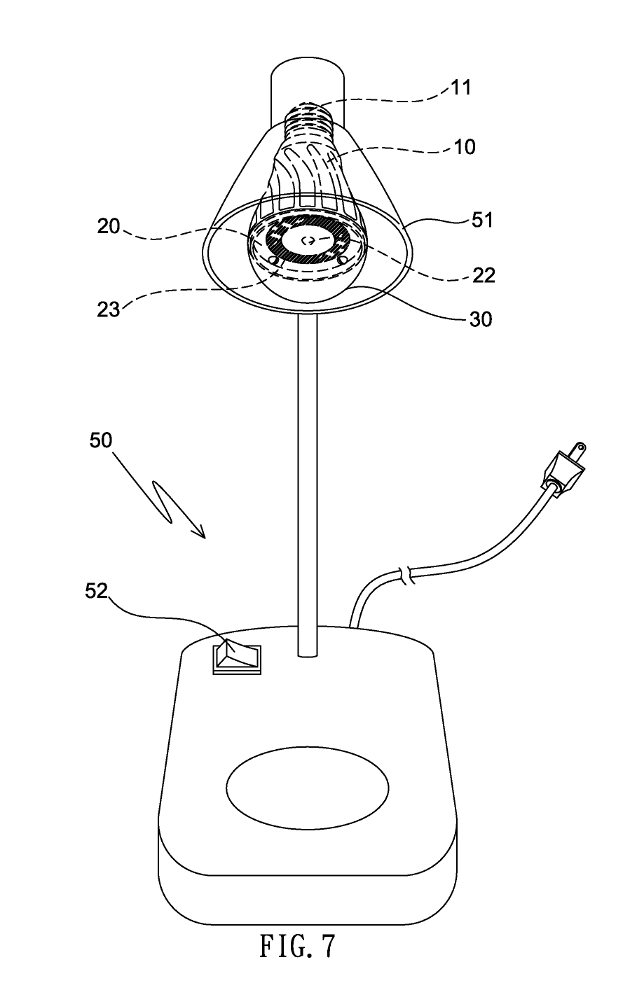

As shown in FIG. 7, the light bulb 10 of the present invention is used as a table lamp 50, wherein the base 11 is connected to the electric power unit in the shade 51. The first LED 22 and the second LEDs 231 are controlled by operating the switch 52. The light bulb can be used as a reading table lamp by activating the second LEDs 231. The light bulb 10 can also be used as a night light by activating the first LED 22.

While we have shown and described the embodiment in accordance with the present invention, it should be clear to those skilled in the art that further embodiments may be made without departing from the scope of the present invention.

What is claimed is:

1. A light bulb comprising:
a base and a top portion connected to the base, a control circuit installed within the top portion and connected with the base;
a board connected to the top portion and having a first Light Emitting Diode (LED) connected to a center thereof, at least one LED unit being located on the board and around the first LED, the at least one LED unit having multiple second LEDs connected thereto which are located around the first LED, the first LED and the second LEDs generating different colors, the first LED and the at least one LED unit electrically connected to the control circuit which controls the first LED and the at least one LED unit to be activated separately or simultaneously, and
a globe connected to the top portion and accommodating the first LED and the at least one LED unit.

2. The light bulb as claimed in claim 1, wherein the base has outer threads.

3. The light bulb as claimed in claim 1, wherein the top portion has a first flange extending therefrom, the globe has a second flange which is connected to the first flange.

4. The light bulb as claimed in claim 1, wherein the board is fixed to the top portion by bolts.
